(19) United States
(12) Patent Application Publication
(10) Pub. No.: US 2008/0115500 A1
(43) Pub. Date: May 22, 2008

(54) Combustion of water borne fuels in an oxy-combustion gas generator

(76) Inventors: Scott MacAdam, El Dorado Hills, CA (US); Roger E. Anderson, Gold River, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/985,399

(22) Filed: Nov. 14, 2007

Related U.S. Application Data
(60) Provisional application No. 60/859,549, filed on Nov. 15, 2006.

(51) Int. Cl. F02B 43/10; F02C 1/00

(52) U.S. Cl. 60/772; 60/39.12

(57) ABSTRACT

A gas generator includes an oxygen inlet, a gaseous fuel inlet, a water, steam and/or CO2 inlet and a water borne fuel inlet. The water borne fuel is combusted within the gas generator along with the oxygen and the gaseous fuel to produce products of combustion including substantially only steam and carbon dioxide. The water borne fuel can be a water fuel solution, emulsion, mixture or other combination. The water borne fuel can either provide only a small portion of the total fuel into the gas generator or provide up to all of the fuel input into the gas generator. The combustion products are discharged from the gas generator and then power is extracted, such as through a turbine. The products of combustion can then be separated, such as within a condenser. Carbon dioxide is thus removed and can be readily sequestered away from the atmosphere to avoid emission of greenhouse gases.

### CROSS-REFERENCE TO RELATED APPLICATIONS

This application claims benefit under Title 35, United States Code §119(e) of U.S. Provisional Application No. 60/859,549 filed on Nov. 15, 2006.

### FIELD OF THE INVENTION

The following invention relates to oxy-fuel combustion power generation systems where a hydrocarbon fuel is combusted with an oxidizer of primarily oxygen. More particularly, this invention relates to oxy-fuel combustion power generation systems which include fuel combined with water diluent to form a water borne fuel for both cooling and supply of fuel for combustion within the gas generator.

### BACKGROUND OF THE INVENTION

Clean Energy Systems, Inc. (“CES”) of Rancho Cordova, Calif. has developed a prior art technology that utilizes oxygen rather than air for hydrocarbon combustion power generation. Such combustion with oxygen is referred to as “oxy-combustion” and can produce power on the megawatt scale with zero or near zero emissions. The process is based on the CES “gas generator” or oxy-fuel combustor that burns gaseous fuels with oxygen in the presence of water to produce a steam/CO2 drive gas for turbines or high-pressure heat exchangers. Details of such oxy-fuel combustion gas generators and systems in which such gas generators are utilized are described in U.S. Pat. Nos. 5,956,937; 6,170,264; 6,206,684; and 6,945,029; incorporated herein by reference in their entirety.

One unique characteristic of the CES oxy-fuel combustor is the fact that it involves the injection of relatively large quantities of water directly into the high-temperature combustion zone. Temperatures in this zone are sufficiently high to convert virtually all of the fuel into H2O and CO2, even with the water present, provided there is sufficient oxygen and residence time to complete the combustion process.

The water is provided to act as a diluent, increasing the mass flow rate of working fluid discharged from the gas generator. Also, the water acts as a coolant to keep walls of the gas generator from exceeding design temperatures, as would be the case if the fuel were combusted with oxygen without any cooling water. CES gas generators have logged over one thousand hours of operation and have operated in systems delivering electric power to the power grid.

Other known prior art oxy-fuel combustion power generation systems have postulated the use of diluent cooling flows other than pure water. In particular, carbon dioxide has been postulated as a diluent for recirculation back to the gas generator by Osgerby (U.S. Pat. No. 4,498,289). The carbon dioxide would typically be gaseous, limiting somewhat its usefulness as a coolant in that the latent heat of vaporization would not be available to absorb heat of combustion within the gas generator.

In prior art oxy-fuel combustion gas generators and power generation systems, the oxygen supply and fuel supply have typically been kept separate from the diluent water supply. In this way, maximum separation of the separate reactants is provided and separate control, such as through appropriate valves and control systems, can be provided to optimize performance of the gas generator. However, once the gas generator is operating in a steady state mode, typically after warmup of the gas generator, the valves and control systems typically do not need to make adjustments to maintain steady state performance.

In at least one oxy-fuel combustion power generation system proposed in the prior art, it has been proposed to introduce the water into the gas generator in a premixed state along with the oxygen. Such a premixture would occur in a gaseous phase with the water as steam, because oxygen and water have no conditions where they are both liquids. In such an arrangement, such a gas generator would only have two inputs including the fuel input and the steam/oxygen input. Such an arrangement has been proposed by Yantovskii in the paper “Computer Exergonomics of Power Plants Without Exhaust Gases,” published in Energy Conversion Management, vol. 33, pp. 405-412. One advantage of such a system is that the hazardous nature of oxygen in its pure state is mitigated somewhat by mixing it with steam, thus making the oxygen supply diluted somewhat akin to its diluted nature as approximately twenty percent of air.

In all such known prior art systems where oxy-fuel combustion is utilized, the fuels have been gaseous at standard atmospheric temperature and pressure. While such gaseous fuels have the benefit of being readily combusted within the gas generator and maximization of a rate of mixing with the oxygen during its combustion reaction, it has been discovered that with the particularly high temperatures attained within gas generators built and tested by the inventors, up to 3,000° F., that liquid fuels can also be effectively combusted therein. In fact, these liquid fuels can be combusted even when premixed with a large amount of water.

In particular, the inventors have performed tests where known prior art oxy-fuel combustion power generation systems such as those provided by Clean Energy Systems, Inc. have been operated with the diluent system, that had previously supplied only water into the combustion chamber, modified to deliver a mixture of fuel and water into the combustion chamber. Simultaneously, an amount of gaseous fuel delivered into the gas generator was reduced. When a similar amount of overall fuel was input to the gas generator, the gas generator could perform similarly whether the fuel was one hundred percent gaseous and supplied through a gaseous fuel inlet, or whether the fuel was partially supplied through the gaseous fuel inlet and partially supplied in a form mixed with the water and delivered through the water/diluent inlet into the gas generator. With a modified injector designed to intimately mix the liquid stream with the oxygen stream, the gaseous fuel inlet can be entirely shut off and the gas generator can operate entirely on oxygen and a water borne fuel. Thus, the possibility of oxy-combustion of a wide variety of water borne fuels, and the related ability to generate power with zero or near zero atmospheric emissions, can be realized.

### SUMMARY OF THE INVENTION

With this invention a gas generator is provided having an enclosure which includes an oxygen inlet, a gaseous fuel inlet, a diluent inlet containing water system and/or carbon dioxide, and a water borne fuel inlet. These inlets all lead into a combustion chamber where the oxygen is combusted with the gaseous fuel and/or fuel within a water borne fuel to produce products of combustion including steam and carbon dioxide. These products of combustion are then delivered to an output where they can be beneficially utilized for power generation. Subsequent separation of the steam from the carbon dioxide can occur so that the carbon dioxide can be sequestered away from the atmosphere. Part of the water separated from the carbon dioxide can be returned to the gas generator with a fuel suitable for forming a fuel component of the water borne fuel, and for return back to the gas generator.

The gaseous fuel inlet of the preferred embodiment could in some instances be utilized merely for starting the combustion reaction and then reduced or shut off entirely, with the gas generator continuing to combust the water borne fuel alone with the oxygen. It is also conceivable that the gaseous fuel inlet could be entirely dispensed with in some embodiments, provided that an appropriate ignition source is provided to initiate combustion of the water borne fuel with the oxygen, even with a large amount of water present.

The fuel within the water borne fuel component could be any of a variety of different liquid or solid fuels. The nature of this water borne fuel could be that of a water/fuel solution, emulsion, slurry, or mixture, or any other combination which includes a first part water and a second part fuel. Such a combination is generally referred to herein by the term “water borne fuel.” The fuel portion can be referred to as a secondary fuel to distinguish it from a gaseous fuel that might be separately provided through a gaseous fuel inlet into the gas generator. This secondary fuel would typically be a liquid at standard temperature and pressure, making it particularly suitable for mixing with the water. However, the secondary fuel could in some instances be a solid, such as finely pulverized coal, petcoke, or other hydrocarbon fuel material. If in solid form, it would most preferably be either very finely ground or otherwise treated so that it can be readily suspended within the water and flow along with the water into the gas generator.

Typically, the gas generator is an elongate cylindrical structure with inlet ports for the oxygen, diluent (water, steam and/or carbon dioxide), water borne fuel and any gaseous fuel at a first end and with an outlet at the opposite end. If the secondary fuel within the water borne fuel is of a type that requires a significant amount of time to complete combustion, a length of the gas generator can be increased so that an amount of time that the fuel is present within the combustor portion of the gas generator can be increased sufficiently to complete such combustion. Other common fuels that could be utilized as the secondary fuel within the water borne fuel include but are not limited to glycerol, methanol, ethanol, higher alcohols and MTBE (methyl tert-butyl ether). The general requirements are that the fuels contain primarily carbon, hydrogen and oxygen and the water-fuel solutions or emulsions or mixtures are essentially free of impurities or are able to be purified before their use.

One embodiment of this concept is the use of glycerol (C3H8O3) as the water-soluble fuel. Glycerol (also called glycerine) is a byproduct of the bio-diesel production process. Due to the rapid expansion of the bio-diesel industry particularly in the U.S. and Europe, and limited demand of glycerol as a chemical feedstock, the availability of this material as a low-cost fuel is expected to grow.

In all embodiments, the water-borne fuel represents a significant fraction of the thermal input to the oxy-combustor, preferably over 10%. Depending on the fuel and its concentration in the solution, it may be possible for it to contribute 100% of the thermal input to the combustor. For example, the injection of a 37% glycerol-water solution with oxygen into a CES oxy-combustor provides sufficient heat to attain the desired 3,000° F. temperature in the combustion chamber. The injection of lower concentration glycerol solutions or the use of lower Btu fuels will require some use of fuel gas (i.e. natural gas or syngas). For example, a 12% glycerol-water solution will represent ⅓ of the thermal input required to attain a chamber temperature of 3,000° F. The water soluble fuel could conceivably be less than 10% of the thermal input also, with such low use systems being typically only marginally different than those without any fuel in the diluent.

In the Direct Cycle, shown in FIG. 1, four separate streams are injected into a CES oxy-combustor: (i) oxygen, (ii) a water-fuel solution or emulsion, (iii) a gaseous fuel and (iv) a diluent (water, steam and/or carbon dioxide). The aqueous fuels may contain any water-soluble or emulsifiable component of fuel value provided it consists of C, H, and/or O. Preferably, this aqueous fuel does not contain impurities that would present corrosion problems or otherwise foul the combustor or downstream power generation equipment. The gaseous fuel will typically represent 0-90% of the thermal input and may include fuels such as natural gas, landfill gas, biodigester gas, or synthesis gas (i.e. mixtures of H2 and CO). The output of the combustor is a high-pressure (typically >100 psia), high-temperature (typically >700° F.) gas comprising steam and CO2 that is used to drive one or more turbines.

In closed loop CES cycles, the exhaust from the final turbine enters a condenser that separates the CO2 by-product from condensate. Most of the water condensate preferably is recirculated to the gas generator at the water-fuel solution inlet or as a diluent directly into the gas generator. Some form of mixer would add the aqueous fuel to this condensate water before its reinjection. The CO2 from the condenser can be readily pressurized and sequestered away from the atmosphere, such as in depleted oil wells where CO2 injection is known for enhanced oil recovery. In open-loop CES cycles, the steam/CO2 is vented to the atmosphere.

This basic direct cycle can be modified in all of the ways disclosed in the patents incorporated herein by reference, such as by adding reheaters and/or feedwater heaters. Such feedwater heaters can be for the water only or the water/soluble fuel mixture before injection into the gas generator.

In the Indirect Cycle, shown in FIG. 2, the same steam/CO2 drive gas enters a high-pressure heat recovery steam generator (HRSG) in lieu of a turbine. In the HRSG, steam (or other working fluid) is produced by exchanging heat between the steam/CO2 products of combustion and feedwater or other working fluid. The steam can be used in a conventional steam turbine (Rankine) cycle and/or as process heat.

The use of low- or zero-cost water-borne fuels in the CES oxy-combustor may reduce the fuel operating costs of a CES plant. For instance, the injection of a 12% glycerol-water solution into the combustor will reduce the amount of required fuel gas (natural gas or other) by one third. With a significant $/MMBtu price differential between natural gas and glycerol, this will have a noticeable impact on the fuel costs of a plant.

Also, the use of renewable water-soluble fuels (such as glycerol from bio-diesel production) or conceivably a water borne biofuel such as algae or pulverized/micronized biomass, may entitle the plant to renewable energy credits. The use of such renewable fuels in a zero-emissions power plant (ZEPP) also provides a negative carbon burden on the atmosphere, actually effectively removing CO2 from the atmosphere; making the power generation system more than merely carbon neutral, but actually acting to reverse global warming.

### OBJECTS OF THE INVENTION

Accordingly, a primary object of the present invention is to provide a gas generator capable of combusting a water borne fuel with oxygen for production of power without the formation of oxides of nitrogen.

Another object of the present invention is to provide a power generation system which combusts a water borne hydrocarbon fuel with oxygen to produce power with near zero atmospheric emissions.

Another object of the present invention is to provide a power generation system which combusts a hydrogen and/or carbon containing fuel with oxygen so that products of combustion are limited to substantially just water and carbon dioxide which can be readily separated for sequestration of the carbon dioxide and avoidance of emission of carbon dioxide or other greenhouse gases.

Another object of the present invention is to generate large quantities of power (on the order of megawatts) without emission of greenhouse gases or otherwise contributing to global warming.

Another object of the present invention is to provide a method for generation of power without atmospheric emissions and which is powered by combustion of a water borne fuel.

Other further objects of the present invention will become apparent from a careful reading of the included drawing figures, the claims and detailed description of the invention.

### BRIEF DESCRIPTION OF THE DRAWINGS

FIG. 1 is a schematic view of a power generation system according to a first embodiment of this invention where a water borne fuel is combusted with oxygen for generation of power within a direct cycle.

FIG. 2 is a schematic of an alternative embodiment of that which is shown in FIG. 1, illustrating an indirect cycle for extraction of power from combustion of a water borne fuel with oxygen.

### DESCRIPTION OF THE PREFERRED EMBODIMENT

Referring to the drawings, wherein like reference numerals represent like parts throughout the various drawing figures, reference numeral 10 is directed to a system for power generation through combustion of a water borne fuel with oxygen according to a direct cycle of this invention. Central to the system 10 of this invention is utilization of a gas generator 20 akin to that described in U.S. Pat. No. 6,206,684 incorporated herein by reference in its entirety. With this invention, pathways that would otherwise be utilized for delivery of cooling diluent water into the gas generator 20 have been replaced with a water borne fuel inlet where a water borne fuel provides both cooling and supply of a combustible fuel for combustion within the gas generator 20.

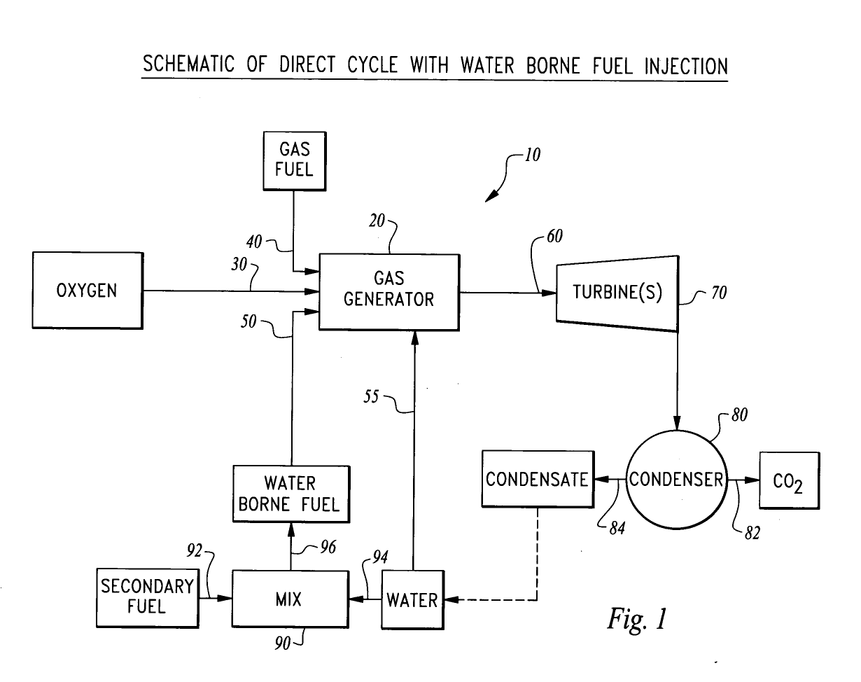

In essence, and with particular reference to FIG. 1, the basic details of the system 10 of this invention are described. The gas generator 20 is coupled to an oxygen inlet 30 coupled to a source of oxygen. A gaseous fuel inlet 40 is also preferably coupled to the gas generator 20, with the gaseous fuel inlet 40 coupled to a source of gaseous fuel. This gaseous fuel inlet 40 could be eliminated in at least one embodiment of this invention. The water borne fuel inlet 50 is coupled to the gas generator 20 and delivers a water borne fuel into the gas generator 20. The diluent inlet 55 is coupled to the gas generator 20 and delivers water, steam and/or CO2 into the gas generator 20 for temperature moderation (if required).

The water borne fuel and any gaseous fuel entering the gas generator 20 are combusted with the oxygen from the oxygen inlet 30 to produce a high temperature (about 3,000° F.) high pressure (100 psi to 1,500 psi typically) stream of combustion products including primarily steam and carbon dioxide. These products of combustion are discharged from the gas generator 20 through the outlet 60.

The products of combustion are then routed through a turbine 70 where the products of combustion are expanded to a lower temperature and pressure and where power is extracted. The products of combustion are then delivered to a separator, preferably in the form of a condenser 80. This condenser 80 cools the products of combustion to the point where water portions of the products of combustion condense, while the carbon dioxide portion remains gaseous. Condensate is removed from the condenser 80 along the condensate output 84. Carbon dioxide is removed from the condenser 80 through a carbon dioxide outlet 82. The carbon dioxide can then be pressurized for delivery into a sequestration site, such as an oil well for enhanced oil recovery therefrom, or into some other sequestration site where the carbon dioxide can be sequestered from the atmosphere.

The condensate in the form of primarily water can be routed in a closed cycle version of this invention back to the gas generator 20. Such return of the water could occur directly through line 55, and also through a mixer 90. This mixer 90 can mix water from the condensate output 84 with a secondary fuel from a secondary fuel entry 92 into the mixer 90. The mixer 90 thus produces a water borne fuel mixture that can be passed from the discharge 96 of the mixer 90 to the water borne fuel inlet 50 of the gas generator 20.

More specifically, and with continuing reference to FIG. 1, particular details of the gas generator 20 are described. The gas generator 20 is typically an elongate cylindrical enclosure with inputs thereto at a first end and an outlet 60 thereof opposite the various inputs. These inputs include an oxygen inlet 30, gaseous fuel inlet 40 and water borne fuel inlet 50.

The oxygen inlet 30 is coupled to a source of oxygen. This source of oxygen could be an output of an air separation plant or could be some other source of oxygen, such as oxygen from an oxygen pipeline, oxygen obtained form electrolysis of water, oxygen obtained from various different chemical reactions, or oxygen merely provided through commercial sale of oxygen to an operator of the system of this invention. The oxygen is delivered into the gas generator 20 through the oxygen inlet 30, preferably in a substantially pure form. To provide at least some of the benefits of this invention, this oxygen inlet 30 preferably delivers a stream of primarily oxygen into the gas generator. Thus, the supply of gas through the oxygen inlet 30 has a greater amount of oxygen than an amount of oxygen present within air.

The gaseous fuel inlet 40 is optionally provided for delivery of a gaseous fuel into the gas generator 20. This gaseous fuel source to which the gaseous fuel inlet 40 is coupled could be any of a variety of different gaseous fuels. Most preferably, the gaseous fuel is methane, or more specifically natural gas which has as a primary constituent methane. However, other gaseous fuels such as syngas and biogases could also be utilized. When natural gas is utilized, it would most typically be provided in the form of a pipeline coupled to natural gas utility service. However, other sources of natural gas or other gaseous fuels could also be utilized including receipt of the gas directly from a natural gas well in the ground, or otherwise supplying natural gas or other gases to the gas generator 20.

In at least one embodiment of this invention, the water borne fuel has sufficient chemical fuel energy in a secondary fuel component of the water borne fuel that no gaseous fuel needs to be supplied to the gas generator 20. In such an instance, the gaseous fuel inlet 40 could still be provided initially for initiation of the combustion reaction within the gas generator 20. Thereafter, a valve could be closed to either reduce or eliminate the flow of gaseous fuel into the gas generator 20. The remaining heat is sufficient to maintain a combustion reaction merely with the water borne fuel and the oxygen. Depending on the chemical energy within the fuel, various different levels of gaseous fuel delivery into the gas generator 20 along the gaseous fuel inlet 40 could be identified as optimal through appropriate experimentation to either maximize power output, maximize utilization of the lowest cost available fuel, or optimization of other performance parameters.

The water borne fuel inlet fuel 50 is coupled to a source of a water borne fuel. This water borne fuel could be any of a variety of different combinations with a first constituent being in the form of water and a second constituent being in the form of a secondary fuel. The general nature of this combination could be that of a mixture, emulsion, solution, slurry, or other combination. The secondary fuel could be any of a variety of different solid or liquid fuels suitable for being carried along with water to form the water borne fuel.

Examples of such secondary fuels include but are not limited to glycerol, methanol, ethanol, higher alcohols, MTBE, petcoke, pulverized coal and other water fuel solutions, emulsions, mixtures, slurries or other combinations. When the secondary fuel is in the form of a solid fuel, it is most preferably very finely ground. It is also conceivable that some form of liquid surfactant, thickening agent or gelling agent could be provided to interface between the water and any solid particles to maximize the ability for the solid fuel particles to remain suspended, so that the water borne fuel requires a minimum of mixing to still deliver a substantially homogeneous mixture of water and a secondary fuel into the gas generator through the water borne fuel inlet 50.

The gas generator 20 typically is generally cylindrical in form with each of the inlets at a first end and with the output 60 at a second end opposite the first end. The gas generator 20 can have a temperature profile that thus is generally hot closer to the first end and cools down as it travels toward the second end. The degree of cooling of the products of combustion from the gas generator can be optimized based on the maximum temperature that can be withstood by the gas generator or based on the residence time at various temperatures necessary for complete combustion of the fuel, re-association or disassociated combustion products and other optimizing parameters.

After an initial combustion chamber portion, the enclosure of the gas generator preferably ends with a plurality of cool down sections where additional water is supplied as a further diluent. Such an arrangement allows the gas generator to maintain a sufficiently high temperature in a combustion chamber portion thereof to cause complete combustion of the secondary fuel within the water borne fuel. Thereafter, however, the products of combustion including steam and carbon dioxide might still be too hot for an expander, such as a turbine, to be utilized with the products of combustion.

To avoid damaging the turbine or other expander and maximize a rate of mass flow through the turbine, additional water can be added to reduce the temperature further and increase a mass flow rate. Such additional water would typically be pure water, rather than a water and fuel mixture, as the introduction of this additional water would typically reduce the temperature below that at which the water borne fuel is readily combusted. Hence, the gas generator 20 preferably includes water inlets close to the outlet 60 which deliver pure water or some other coolant substantially free of any fuel component, for additional cooling of the products of combustion.

These cool down chambers would typically be spaced sufficiently far from the combustion chamber of the gas generator so that the residence time required for complete combustion of the secondary fuel of the water borne fuel can be attained. If necessary, a length of the gas generator 20 can be increased to further increase an amount of residence time within the combustion chamber portion of the gas generator enclosure before the cool down sections of the gas generator are reached and the combustion reaction ceases. Similarly, the residence times in the cool down chamber and the intermediate temperatures are selected to permit efficient re-association of combustion by-products and intermediate combustion products.

With continuing reference to FIG. 1, other details of the system of this preferred embodiment are described. The outlet 60 of the gas generator discharges the products of combustion from the gas generator 20 and delivers them to the turbine 70 or other expander. The products of combustion include substantially steam and carbon dioxide. In at least one embodiment an amount slightly greater than one percent of the products of combustion is in the form of argon which remains as a residual from separation of oxygen from air. Other constituents within the products of combustion would be present in typically only very small amounts, such as trace amounts of carbon monoxide resulting from some less than complete reaction of the fuel with the oxygen within the gas generator, and perhaps excess oxygen. Each of these gases pass through the turbine 70 or other expander along with the primary constituents of the working fluid in the form of steam and carbon dioxide.

The products of combustion are then routed to a condenser 80 for separation of gaseous and liquid portions of the products of combustion. In particular, the condenser 80 preferably cools the products of combustion to the point where water within the products of combustion condense and gaseous portions can be removed separate from condensate portions. The gaseous portions would be primarily carbon dioxide but might also include small amounts of excess oxygen, argon, carbon monoxide and other trace amounts of other compounds. Also, typically a significant amount of water vapor remains present within the carbon dioxide at least upon initial removal from the condenser 80.

The primarily carbon dioxide stream leaves the condenser through the carbon dioxide output 82. This carbon dioxide output 82 then preferably leads to various different items of conditioning equipment including dryers for removal of water vapor therefrom, compressors for compressing of the carbon dioxide, and potentially even liquification of the carbon dioxide, and potentially separators, such as to extract argon or other constituents from the carbon dioxide depending on the use of the carbon dioxide.

Most preferably, the carbon dioxide is sequestered separate from the atmosphere, such that the avoidance of emission of greenhouse gases is achieved, and the phenomena of global warming is not encouraged. Options for such sequestration away from the atmosphere include pressurization and injection into depleted oil wells for enhanced oil recovery, injection into deep saline aquifers or other underground terrestrial formations, injection to deep sea locations, bottling and use of the carbon dioxide as a supply for carbon dioxide in industrial gas uses, and potential other sequestration methodologies now known or developed in the future, including technologies where the carbon dioxide is transformed into a solid form, such as within constituents of compounds such as calcium carbonate or a mineral carbonate.

In a simplest form of this invention, all of the non-condensable gases including argon, carbon monoxide, excess oxygen, and any other gaseous constituents in trace amounts along with the carbon dioxide can be compressed and injected into a sequestration site along with the carbon dioxide. Only in applications where having impurities within the carbon dioxide propose some negative, would it be necessary to take further steps to purify the carbon dioxide before such sequestration.

The condensate formed within the condenser 80 is discharged from the condenser 80 through the condensate output 84. This condensate is typically primarily water. The water in excess of that required for recirculation can be discharged from the system if desired so that the system generally operates as an open cycle. Most preferably, however, this substantially pure water is routed back to the gas generator 20, such as to provide any cooling water for the combustion zone (if required) and for the cool down sections at the end of the gas generator adjacent the outlet 60. Another use for this condensate is to be utilized within a mixer 90 where the water borne fuel is manufactured. Such a mixer 90 includes a secondary fuel entry 92 and a water entry 94 where the secondary fuel is mixed with water to form the water borne fuel. A discharge 96 from the mixer 90 leads to the water borne fuel inlet 50 of the gas generator 20.

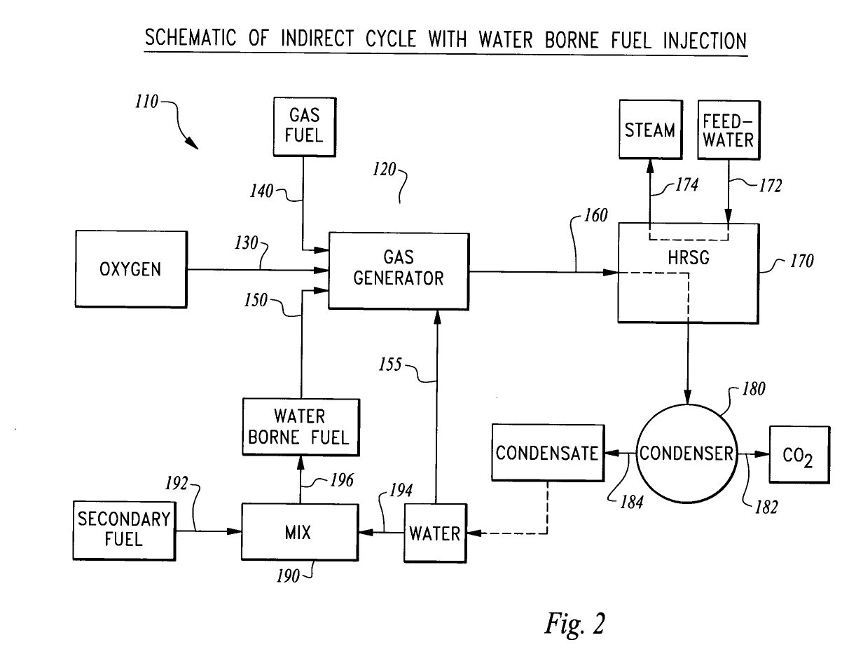

With particular reference to FIG. 2, details of an alternative indirect system 110 are described. This alternative system 110 is generally similar to the direct cycle system 10 of FIG. 1. Thus, a gas generator 120 is utilized which includes an oxygen inlet 130, a gaseous fuel inlet 140, a diluent inlet 155 and a water borne fuel inlet 150. An outlet 160 discharges a combustion products stream of substantially steam and carbon dioxide from the gas generator 120.

Unique to the indirect cycle of the alternative system 110 is that the turbine 70 is replaced with a heat recovery steam generator 170. This heat recovery steam generator 170 is generally in the form of a heat exchanger. Heat within the products of combustion is transferred to a separate working fluid. This separate working fluid would most typically be water from a feedwater input 172. This feedwater is heated within the heat recovery steam generator so that a steam output 174 is provided from the heat recovery steam generator 170. This steam could then be used to drive a turbine or some other expander, or could be utilized as process heat, depending on the particular needs of the user.

The products of combustion leave the heat recovery steam generator 170 at a lower temperature. Typically, they still have a high pressure matching that of the performance of the gas generator 120. If desired, these products of combustion could be expanded with optionally further power extracted through this expansion.

The products of combustion are then routed to a condenser 180 where the carbon dioxide output 182 is provided separate from a condensate output 184. As with the preferred embodiment of FIG. 1, the water from the condensate output 184 could be discharged from the system, could be returned to the gas generator 120 through diluent path 155 or could be routed to a mixer 190 through a water entry 194. The mixer 190 also includes a secondary fuel entry 192 where the mixer 190 receives fuel for mixing with the water from the water entry 194. This water borne fuel is then passed to the discharge 196 for delivery of the water borne fuel to the water borne fuel inlet 150. Some of the CO2 output 182 can be compressed and re-injected into the gas generator 120 to supplement the cooling provided by recirculated water streams 155 and 194.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A water borne fuel combusting gas generator, comprising in combination:
an enclosure;
said enclosure having an oxygen inlet coupled to a source of oxygen, said oxygen inlet adapted to draw oxygen into said enclosure for reaction with a fuel;
said enclosure having a gaseous fuel inlet coupled to a source of gaseous fuel, said gaseous fuel inlet adapted to draw gaseous fuel into said enclosure for combustion with the oxygen from said oxygen inlet;
said enclosure having a water borne fuel inlet coupled to a source of water borne fuel, said water borne fuel inlet adapted to draw the water borne fuel into said enclosure with the water borne fuel being combusted with the oxygen from said oxygen inlet;
said enclosure having a chamber downstream from said oxygen inlet, said gaseous fuel inlet and said water borne fuel inlet, said chamber adapted to allow combustion of the oxygen, the fuel and the water borne fuel to produce products of combustion including steam and carbon dioxide; and
said enclosure having an outlet adapted to discharge steam and CO2 therefrom.

2: The gas generator of claim 1 wherein said oxygen inlet is configured to receive sufficient oxygen to oxidize substantially all of the gaseous fuel and the water borne fuel within said chamber.

3: The gas generator of claim 1 wherein said water borne fuel inlet includes a plurality of entry ports spaced from each other on a wall of said chamber such that the water borne fuel passing through the water borne fuel inlet cools said wall of said chamber before combustion of the water borne fuel.

4: The gas generator of claim 3 wherein said oxygen inlet and said gaseous fuel inlet each include a plurality of entry ports spaced from each other and from inlet ports for said water borne fuel with said oxygen inlet ports dispersed amongst said gaseous fuel inlet ports and said water borne fuel inlet ports to promote mixing and complete combustion of the gaseous fuel and the water borne fuel within said chamber.

5: The gas generator of claim 4 wherein said oxygen inlet ports, said gaseous fuel inlet ports and said water borne fuel inlet ports are sized and provided in appropriate numbers to match ratios of oxygen, gaseous fuel and water borne fuel necessary for complete combustion into steam and carbon dioxide within said chamber.

6: The gas generator of claim 5 wherein said oxygen inlet ports are sized to provide sufficient oxygen to complete combustion of the gaseous fuel on the water borne fuel, such that excess oxygen is provided within said chamber to drive a combustion reaction occurring within said chamber to complete combustion of the gaseous fuel and the water borne fuel therein.

7: The gas generator of claim 1 wherein said gaseous fuel inlet includes a valve for controlling flow of said gaseous fuel into said chamber, such that a flow rate of gaseous fuel through said gaseous fuel inlet and into said chamber can be adjusted during operation of the gas generator.

8: The gas generator of claim 1 wherein said water borne fuel source supplies a water borne fuel formed of a majority water.

9: The gas generator of claim 1 wherein said enclosure has a diluent inlet coupled to a source of diluent, said diluent inlet downstream from said chamber.

10: The gas generator of claim 9 wherein said source of diluent includes water.

11: The gas generator of claim 9 wherein said source of diluent includes carbon dioxide.

12: A method for combustion of a water borne fuel without release of air pollution or greenhouse gases, comprising in combination:
providing a gas generator having an enclosure, the enclosure having an oxygen inlet coupled to a source of oxygen, the oxygen inlet adapted to draw oxygen into the enclosure for reaction with a fuel; the enclosure having a water borne fuel inlet coupled to a source of water borne fuel, the water borne fuel inlet adapted to draw the water borne fuel into the enclosure with the water borne fuel being combusted with the oxygen from the oxygen inlet; the enclosure having a chamber downstream from the oxygen inlet and the water borne fuel inlet, the chamber adapted to allow combustion of the oxygen and the water borne fuel to produce products of combustion including primarily steam and carbon dioxide; and the enclosure having an outlet adapted to discharge steam and carbon dioxide therefrom;
combusting the oxygen with the water borne fuel within the gas generator to produce products of combustion including primarily steam and carbon dioxide;
extracting power from the products of combustion;
separating the products of combustion into a primarily carbon dioxide path and a primarily water path; and
pumping the carbon dioxide to an elevated pressure for delivery of the carbon dioxide into a sequestration site separate from the atmosphere.

13: The method of claim 12 wherein said power extracting step includes the step of expanding the products of combustion through an expander.

14: The method of claim 12 wherein said power extracting step includes the step of routing the products of combustion through a heat exchanger where the products of combustion give up heat to a working fluid in a separate power extraction system.

15: The method of claim 12 including the further step of recirculating water from the primarily water path downstream of the separator back to the gas generator.

16: The method of claim 15 including the further step of mixing the water from the primarily water path downstream of the separator of said separating step with a fuel to form a water borne fuel; and
routing the water borne fuel of said mixing step to the water borne fuel inlet of the gas generator.

17: The method of claim 12 wherein said separating step includes the step of condensing the products of combustion including steam and carbon dioxide so that the water condenses into a liquid state and the carbon dioxide remains gaseous.

18: The method of claim 17 wherein at least a portion of the carbon dioxide from said separating step is routed back to the gas generator as a diluent.

19: The method of claim 12 wherein said providing a gas generator step includes the step of configuring the source of water borne fuel coupled to the water borne fuel inlet to be a majority water.

20: A near zero emissions water borne fuel combustion power production system, comprising in combination:
a gas generator having an enclosure, said enclosure having an oxygen inlet coupled to a source of oxygen, said oxygen inlet adapted to draw oxygen into said enclosure for reaction with a fuel; said enclosure having a water borne fuel inlet coupled to a source of water borne fuel, said water borne fuel inlet adapted to draw the water borne fuel into said enclosure with the water borne fuel being combusted with the oxygen from said oxygen inlet; said enclosure having a chamber downstream from said oxygen inlet and said water borne fuel inlet, said chamber adapted to allow combustion of the oxygen and the water borne fuel to produce products of combustion including primarily steam and carbon dioxide; and said enclosure having an outlet adapted to discharge steam and CO2 therefrom;
an expander downstream from said outlet of said gas generator, said expander adapted to expand the products of combustion to a lower pressure and output power;
a separator downstream from said expander, said separator adapted to separate at least a portion of water within the products of combustion from at least a portion of carbon dioxide within the products of combustion; and
a compressor adapted to compress carbon dioxide from said separator to an elevated pressure for delivery of the carbon dioxide into a sequestration site separate from the atmosphere.

21: The system of claim 20 wherein said separator includes a condenser with a condensate outlet for primarily water and a gaseous outlet for primarily carbon dioxide.

22: The system of claim 21 wherein said condensate outlet is coupled to said gas generator for recirculation of at least a portion of the water condensed within said condenser.

23: The system of claim 22 wherein a mixer is interposed between said condenser and said water borne fuel inlet, said mixer adapted to mix water discharged as condensate from said condenser with a fuel to produce the water borne fuel for delivery to the water borne fuel inlet of said gas generator.

24: The system of claim 20 wherein said source of water borne fuel includes a source of fuel which is a greater proportion water than fuel.
